(19) United States
(12) Patent Application Publication
(10) Pub. No.: US 2003/0189346 A1
(43) Pub. Date: Oct. 9, 2003

(54) Multi-function cooking utensil

(76) Inventors: Donald M. Leydens, Pittsboro, NC (US); Patricia Leydens, Pittsboro, NC (US)

Correspondence Address: Donald W. Meeker, 924 East Ocean Front, #E, Newport Beach, CA, 92261, US

(21) Appl. No.: 10/119,248

(22) Filed: Apr. 8, 2002

(51) Int. Cl. A47J 43/28

(52) U.S. Cl. 294/5.5

(57) ABSTRACT

A bowl extends almost perpendicularly from a straight handle to serve as a ladle and spoon. An indentation on the edge of the bowl on each side allows a small quantity of food to be poured from the bowl on either side for pouring or tasting. A front edge of the bowl is straight across and wedge-shaped with flat top and bottom surfaces adjacent to the edge serves as a spatula and scraper. A thick portion of the handle serves as an ergonomic grip.

### BACKGROUND OF THE INVENTION

1. Field of the Invention

The present invention relates to cooking utensils and in particular to a multi-function cooking utensil that combines in one tool a spatula, a scraper, a ladle, a spoon, and a tasting vessel.

2. Description of the Prior Art

With the large number of cooking utensils people usually have in their drawer or other kitchen storage area, it is sometimes difficult to find the one you want. Generally for cooking you perform a number of functions on each food item, often requiring several utensils for the same dish: one for stirring, one for scraping the bottom of the pot or pan, one for spooning ingredients, one for ladling soup, stock or sauce, and one for tasting.

It is a nuisance to have a number of cooking utensils along with mixing bowls, food containers, pots, pans, cook books, and other items all vying for a limited amount of space on a countertop or stove.

Another problem is getting the right kind of kitchen utensil, preferably one which does not damage modern cooking surfaces. Wooden utensils are attractive, practical tools for a wide variety of cooking functions and will not scratch cooking surfaces.

Finding just the right kind of utensil at the store is not always that easy or sometimes impossible because of a limited number of certain types of items being sold, such as wooden spoons. Wooden spoons that you find in the store are often limited in number and design.

Wooden spoons are usually too flat to hold much food or liquid. When you try to taste what you are cooking, the long spoons are too straight and long to get an adequate enough angle to collect much food/liquid.

A very important aspect of cooking is to be able to scrape the bottom of pots and pans while you are cooking. A round ended spoon is inefficient.

While there have been a number of attempts at creating multipurpose cooking utensils, the prior art still fails to address all of the problems.

U.S. Pat. No. 2,589,753, issued Mar. 18, 1952 to Vinson, claims a kitchen utensil with a spoon-like bowl having a straight flat scraping blade and a flat top edge slightly angled slightly from the straight handle.

U.S. Pat. No. 5,092,050, issued Mar. 3, 1992 to Bardeen, provides a hand held scraping device having a concave scoop portion with a relatively flat top edge attached at a very slight angle to a straight handle.

U.S. Pat. No. 4,524,513, issued Jun. 25, 1985 to Intini, shows a flat tip spoon or culinary spoon having a bowl with a forwardly extending flat tip. The front edge of the flat tip end area portion may be convexly curvate, straight edge, indented or multi-lobed. The relatively flat top of the spoon aligns evenly with a relatively straight handle.

U.S. Pat. No. 2,012,637, issued Aug. 27, 1935 to Ribley, describes a bowl-shaped spoon having a relatively flat front tip, which seem to align directly with the straight handle, which has a thick portion for easier gripping.

U.S. Pat. No. 2,251,842, issued Aug. 5, 1941 to Hill, discloses a corn sheller having a somewhat recessed spoon-like portion and a flat tip which is partly straight and partly indented, the spoon-like portion aligned directly with the relatively straight handle.

U.S. Pat. No. 2,674,793, issued Apr. 13, 1954 to Dominick, indicates a spoon having a shallow spoon portion with a straight angled tip and a flat top aligned with a straight handle.

U.S. Pat. No. Des. 304,540, issued Nov. 14, 1989 to Howard, puts forth a design for a spoon for use by the handicapped having a bowl with a flat straight edge angled off to the side and having a slight dip between the straight edge and the handle. The flat top edge of the spoon aligns with the straight flat handle.

U.S. Pat. No. 2,457,037, issued Dec. 21, 1948 to Fadeley, concerns a compound culinary implement having an interchangeable spoon head and scraper head combination pivotally connected to a handle, either of which can be pivoted into place at the front end of the handle. The flat top of the spoon aligns with the straight flat handle.

U.S. Pat. No. 6,012,750, issued Jan. 11, 2000 to Swartz, illustrates a spatula having a recessed dip in the blade to hold things, like hot dogs. The flat spatula surface is aligned with the straight flat handle.

Until now, there still remained the need for a cooking utensil to satisfy all of the needs of a cook for a spatula, a scraper, a ladle, a spoon, and a tasting vessel all combined into one tool.

### SUMMARY OF THE INVENTION

The primary object of the present invention is to combine a spatula, a scraper, a ladle, a spoon, and a tasting vessel all together into one kitchen tool that satisfies all the needs of a cook in one tool.

A corollary object of the present invention is to create an end portion of the invention as a ladle that curves dramatically away from the handle to create a deep bowl portion angled away from the handle that enables dipping the utensil deeply into a pot for ladling large portions of the food being prepared.

Another related object of the present invention is to create a working tip on the end of the invention with a very broad straight scraping edge with pointed corners to be able to scrape the bottoms of pans effectively.

An associated object of the present invention is to provide the invention with a straight somewhat thin front edge of the utensil that serves as a spatula to make it easier to pick up food and flip the food over or perform other functions of a spatula.

A further connected object of the present invention is having left and right recesses or dimples on the sides of the bowl of the utensil for easy pouring and for sipping and tasting the food while cooking.

Another associated object of the present invention is to provide a cooking utensil with an ergonomic gripping portion on the handle to make it easier to perform long stirring tasks and to enable the use of the utensil by people who have manual dexterity difficulties.

One more object of the present invention is to provide the multi-use utensil in various sizes for different uses: small—for little pots and pans, medium—for sautéing and medium sized pots and pans, and large—for stock and sauce made with larger sized pots and pans.

In brief, a multi-function kitchen utensil has a straight, ergonomic handle having an enlarged diameter hand grip portion in the upper portion of the handle to facilitate use and to ease long stirring tasks. Angled at almost forty-five degrees from the handle at the working end is a deep spoon bowl that enables the invention to be dipped deeply into pots and pans and scoop up a large quantity of the food for ladling. Two semi-circular recesses, one on each side of the bowl portion enable easy pouring and tasting of the food in the bowl portion. The front edge of the bowl portion extends straight across the bowl tapering to a relatively sharp and straight front edge, which terminates in a pointed tip at each end to enable picking up and flipping or manipulating food and scraping.

The multi-function kitchen utensil is preferably fabricated of hard wood to enable usage on all cooking surfaces. It may be provided with a hole through the handle adjacent to the end of the handle for hanging the tool for storage.

An advantage of the present invention is that it provides a cooking utensil which is convenient and easy to use serving as a spatula, a scraper, a ladle, a spoon, and a tasting vessel all together into one kitchen tool that satisfies all the needs of a cook in one tool that the cook can keep in hand. The invention can be transferred from a pot to a pan to anything cooking on the stove.

A related advantage of the present invention is that it provides a comfortable method to stir food, taste food, move food around, such as during seautéing, and allows for the scraping of a pot and pan without causing any surface damage.

Another advantage of the present invention is that it stores easily as a single tool without the clutter of many tools in a storage drawer.

An additional advantage of the present invention is that it is a single tool that may be held in hand or placed at a convenient location on the cooking work surface so that it is easy to find rather than having a number of tools taking up work space on the counter.

One more advantage of the present invention is that it provides a wooden ladle that is capable of holding a large quantity of the food being cooked, whereas most wooden utensils are flat and hold little food.

A further advantage of the present invention is that with its scraping function combined with the other functions performed while cooking, the scraping function is performed more frequently and the invention greatly reduces the amount of wasted food, sauce, flavorings, etc. which normally stick to a heated pot and aids in the cleaning of such pot.

Again another advantage of the present invention is that it is provided with an ergonomically efficient handle to provide a firmer “hand-friendly” grip for the average adult hand.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a side elevational view of the invention showing all the features of the invention including the bowl shown dashed;

FIG. 2 is a front elevational view of the invention;

FIG. 3 is a side elevational view of an alternate embodiment of the invention having a more shallow bowl.

### BEST MODE FOR CARRYING OUT THE INVENTION

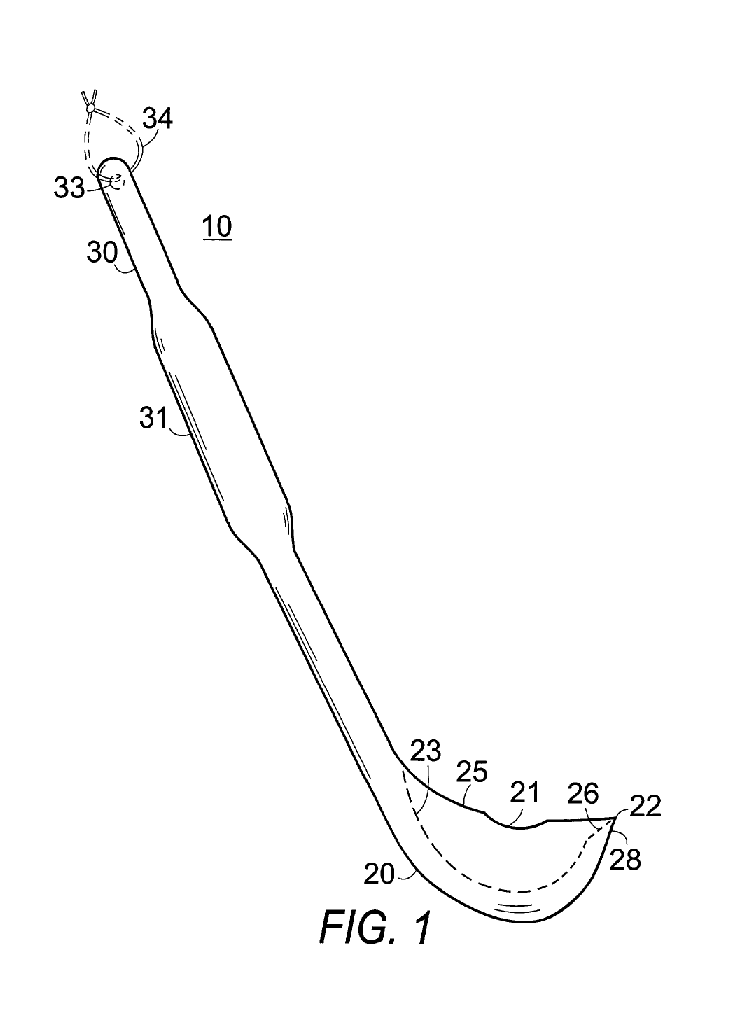

In FIGS. 1, 2, and 3, a multi-function kitchen utensil 10 and 10A comprises a straight rigid handle 30 and a working head 20 extending from a distal end of the handle and angled away from the handle so that with the handle held almost vertically the working head is horizontal.

The working head 20 has a concave bowl 23 capable of holding a quantity of food and capable of being dipped deeply into a cooking container as a ladle. The bowl 23 has a ridge 25 on two sides of the bowl. Each ridge has an arched indentation 21 capable of releasing a portion of the food from the bowl for tasting or pouring with the working head tipped to one side. A transverse straight front edge 22 is tapered to a wedge point capable of scraping cooking containers as a scraper and sliding under food to lift the food as a spatula. The straight front edge 22 further comprises a flat underside 28 portion to facilitate scraping cooking surfaces and a flat top portion 26 to facilitate lifting food and scraping cooking surfaces.

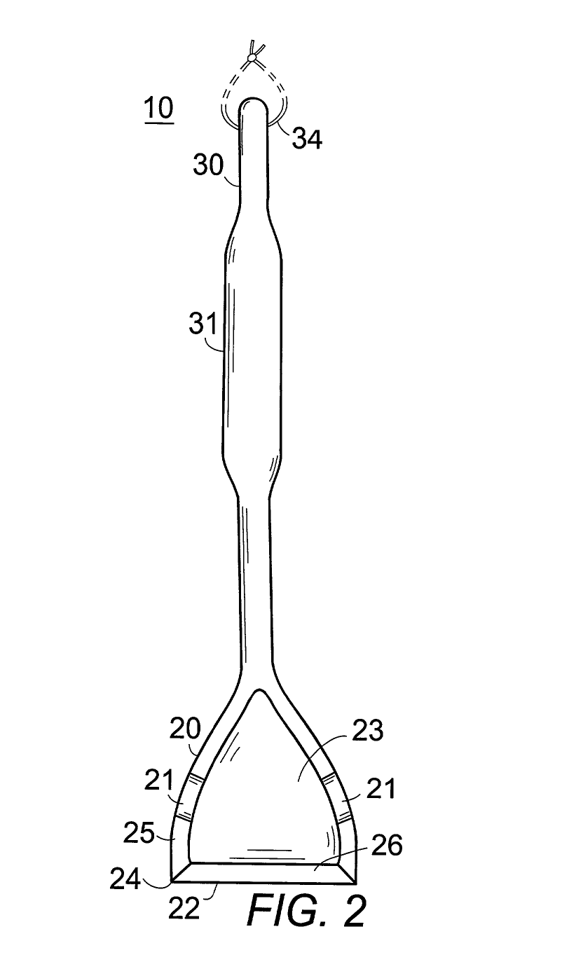

As seen in FIG. 2, the straight front edge 22 terminates in a point 24 at each side where the front edge 22 meets the ridge 25 on each side of the bowl to enable the working head to contact simultaneously a bottom surface and a perpendicular side surface of a cooking container for scraping the surfaces.

The handle is provided with one portion of the handle forming an ergonomic gripping portion 31 adjacent to a proximal end of the handle, the ergonomic gripping portion being thicker than the rest of the handle so that it may be gripped and held comfortably for a long period of time, especially useful in stirring operations.

The handle 30 preferably has a circular cross-section and is preferably provided with an opening 33 therethrough adjacent to the proximal end of the handle enabling the utensil to be hung up for storage either on an external hook or nail directly through the opening 33 or using a piece of rawhide 34 or other cord-like means for hanging.

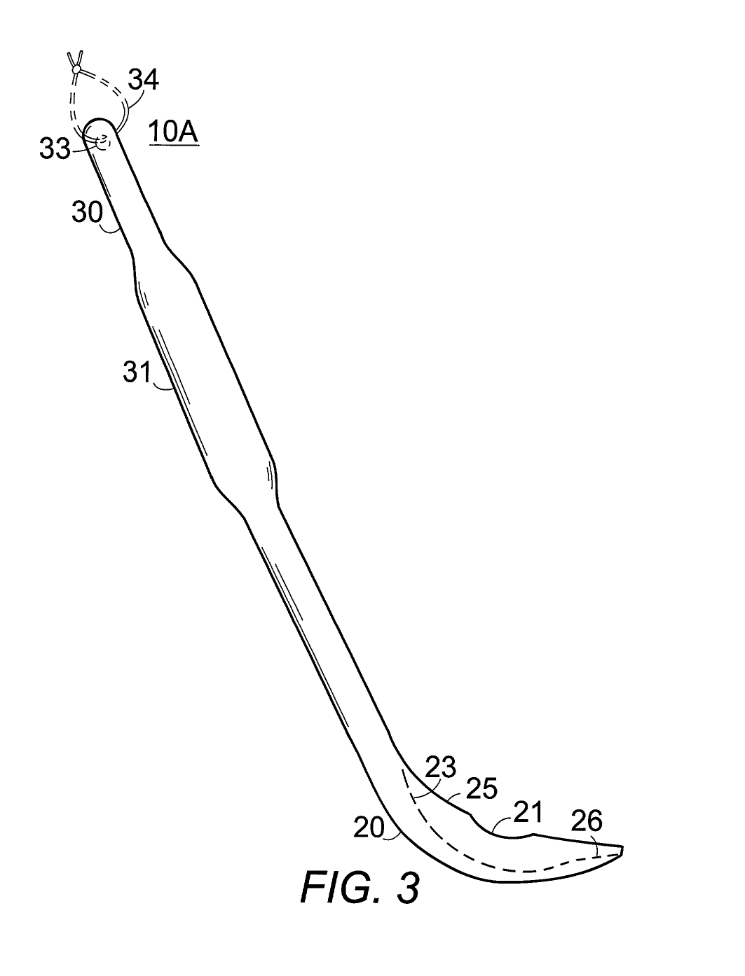

In FIG. 3 an alternate embodiment of the multi-function cooking utensil 10A has a more shallow bowl 23 than the embodiment of FIG. 1 and represents the medium size multi-function kitchen utensil 10A useful for seautéing and for use in medium sized pots and pans. The large and small multi-function kitchen utensil are characterized by deeper bowls 23 as seen in FIG. 1, the small version being useful for little pots and pans and the large version for stock and sauce made with larger sized pots and pans.

The utensil is preferably fabricated of finished hard wood as a pleasing natural material which is comfortable to hold and is safe to use on all cooking surfaces. The utensil may also be fabricated of molded plastic or metal or any other rigid material not adversely affected by the heat and moisture of cooking food.

In use, the multi-function cooking utensil 10 and 10A may be held comfortably for long periods of time and used for ladling, stirring, lifting, tasting, pouring, and mixing food as well as scraping the cooking surfaces.

It is understood that the preceding description is given merely by way of illustration and not in limitation of the invention and that various modifications may be made thereto without departing from the spirit of the invention as claimed.

What is claimed is:

1. A multi-function kitchen utensil comprising:
a straight rigid handle;
a working head extending from a distal end of the handle and angled away from the handle so that with the handle held almost vertically the working head is horizontal, the working head having a concave bowl capable of holding a quantity of food, the bowl having a ridge on two sides of the bowl, each ridge having an arched indentation capable of releasing a portion of the food from the bowl for tasting or pouring with the working head tipped to one side, and a transverse straight front edge tapered to a wedge point capable of scraping cooking containers and sliding under food to lift the food.

2. The multi-function kitchen utensil of claim 1 wherein the handle further comprises at least one portion of the handle forming an ergonomic holding portion adjacent to a proximal end of the handle, the ergonomic holding portion being thicker than the rest of the handle so that the ergonomic holding portion may be gripped and held comfortably for a long period of time.

3. The multi-function kitchen utensil of claim 1 wherein the handle has a circular cross-section.

4. The multi-function kitchen utensil of claim 1 wherein the handle is provided with an opening therethrough adjacent to the proximal end of the handle enabling the utensil to be hung up for storage.

5. The multi-function kitchen utensil of claim 1 wherein the straight front edge terminates in a point at each side where the front edge meets the ridge on each side of the bowl to enable the working head to contact simultaneously a bottom surface and a perpendicular side surface of a cooking container for scraping the surfaces.

6. The multi-function kitchen utensil of claim 1 wherein the straight front edge further comprises a flat underside portion to facilitate scraping cooking surfaces.

7. The multi-function kitchen utensil of claim 1 wherein the straight front edge further comprises a flat top portion to facilitate lifting food and scraping cooking surfaces.

8. The multi-function kitchen utensil of claim 1 wherein the utensil is fabricated of wood.

9. The multi-function kitchen utensil of claim 1 wherein the utensil is fabricated of molded plastic.

10. The multi-function kitchen utensil of claim 1 wherein the utensil is fabricated of metal.
